(19) United States
(12) Patent Application Publication
(10) Pub. No.: US 2018/0044544 A1
(43) Pub. Date: Feb. 15, 2018

(54) HIGH PERFORMANCE COATING

(71) Applicant: Valspar Sourcing, Inc., Minneapolis, MN (US)

(72) Inventor: Nancy A. Peden, Garland, TX (US)

(73) Assignee: Valspar Sourcing, Inc., Minneapolis, MN (US)

(21) Appl. No.: 15/794,088

(22) Filed: Oct. 26, 2017

Related U.S. Application Data
(63) Continuation of application No. PCT/US2016/031985, filed on May 16, 2016.
(60) Provisional application No. 62/160,362, filed on May 12, 2015.

(51) Int. Cl. C09D 7/12; C08K 3/40; C09D 5/28; C09D 127/16

(52) U.S. Cl. CPC C09D 7/1291; C09D 127/16; C08K 3/40; C09D 5/28

(57) ABSTRACT

A coated article that demonstrates a sparkle effect and vibrant color over an expanded range of color space is described. A first coating of at least one fluoroolefin and at least one pigment is applied to a substrate, followed by a second coating of at least one fluoroolefin and at least one effect additive. The effect additive is glass flake designed to provide a sparkle effect. The cured film may be provided in a wide range of colors warrantied similar to conventional coatings. A method of making these coated articles is also provided.

### CROSS-REFERENCE TO RELATED APPLICATION(S)

10011 This application is a continuation of International Application No. PCT/US2016/031985 filed on 12 May 2016, which claims priority to U.S. Provisional Application Ser. No. 62/160,362, filed on 12 May 2015, each of which are incorporated herein by reference in its entirety.

### BACKGROUND OF THE INVENTION

Coil and extrusion coatings are frequently used to coat metal substrates in an economical manner. Such coatings are known to have a number of useful properties such as abrasion resistance, flexibility, durability, corrosion resistance, weather resistance, resistance to cracking and the like.

Coil and extrusion coatings are used to impart durable, colorful aesthetics in a wide range of applications, including metal building products. Extrusion coatings, also known as spray coatings, are applied by hand or electrostatically to preformed metal components such as curtain walls, store fronts, windows, louvers, and the like, while coil coatings are roll-coated onto planar metal sheets that are postformed into architectural components such as building panels, roofing, siding, and the like.

Metal effects are sometimes used to provide an optically attractive coating, such as a colored coating with a sparkle finish or a pearlescent finish. Conventionally, mica and alumina are used to achieve this effect by including mica or aluminum in a coating composition that also includes pigment to impart color to the coating. However, when mica is used to provide sparkle or metal effect, the vibrancy of color is sacrificed, particularly in spray coatings as film thickness tends to vary and color consistency with dark base coat colors is difficult to achieve. Conversely, if the color is maintained, it is not possible to achieve the sparkle or metal effect with just mica.

Accordingly, there is a need for coil and spray coated articles that demonstrate a desirable aesthetic effect like sparkle while also maintaining color vibrancy. Such coated articles and methods of making the same are disclosed herein.

### SUMMARY

The present description provides a coated article that includes a substrate and a first coating applied on the substrate, where the first coating includes a cured film formed from a first composition that includes at least a fluorinated resin. The coated article further includes a second coating applied over the first coating, where the second coating includes a cured film formed from a second composition that includes at least a fluorinated resin and glass flakes. The second coating provides the coated article a sparkle finish.

The present description also provides a method for making a coated article with a sparkle finish. The method includes steps for providing a substrate followed by applying on the substrate a first coating composition including at least a fluorinated resin. A second clear coating composition is applied on the substrate (over the first composition) where the second coating composition includes at least a fluorinated resin and glass flakes. The method further includes the steps of curing the first and second coating compositions sequentially to provide a coated article with sparkle finish.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

The details of one or more embodiments of the invention are set forth in the accompanying drawings and the description below. Other features, objects, and advantages of the invention will be apparent from the description and drawings, and from the claims.

### BRIEF DESCRIPTION OF FIGURES

FIG. 1 is a photographical representation comparing a spray coated article according to the present description with a conventional coated article that includes mica or aluminum flake.

FIG. 2 is a photographical representation of coated articles according to the present description having a wide range of color and a sparkle finish.

### SELECTED DEFINITIONS

Unless otherwise specified, the following terms as used herein have the meanings as provided below.

The term “component” refers to any compound that includes a particular feature or structure. Examples of components include compounds, monomers, oligomers, polymers, and organic groups contained there.

The term “dispersion” in the context of a dispersible polymer refers to the mixture of a dispersible polymer and a carrier. The term “dispersion” is intended to include the term “solution.”

Unless otherwise indicated, a reference to a “(meth)acrylate” compound (where “meth” is bracketed) is meant to include both acrylate and methacrylate compounds.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Unless otherwise indicated, the term “polymer” includes both homopolymers and copolymers (i.e., polymers of two or more different monomers).

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

The present description features coated articles having a sparkle finish and methods of making coated articles with a sparkle finish. As used herein, the term “sparkle finish” refers to a coating that has a shimmer, glitter or pearlescent effect and can have the appearance of gold, silver, other metallic materials, and combinations thereof. Such a sparkle finish is intended to produce an optically attractive effect without negative impact on the color vibrancy or color accuracy of the coating system.

The coated article described herein is preferably a metal article, more preferably a spray-coated metal article or coil-coated metal sheet. Any metal may be used, such as aluminum, iron, copper, tin, steel, and the like. Aluminum and steel are preferred, with aluminum particularly preferred.

Spray and coil-coated metals are high performance materials used in a wide variety of applications including, for example, metal building panels, metal roofs, wall panels, garage doors, office furniture, home appliances, heating and cooling panels, automotive panels and parts, and the like. In a preferred aspect, the coated article has a sparkle finish and may be used in curtain walls, windows, doors, panels, skylights, atrium systems, louvers, grilles, column covers and any sort metal building components. For example, spray-coated articles as described herein could be used as attractive accent walls in various locations including, for example, theme parks, casinos, restaurants, theatres, and the like.

In an embodiment, the present description provides a coated article, i.e. a substrate, preferably a metal substrate, with one or more coating compositions applied thereon. For coil and spray coated articles, it is conventional to apply a primer coating to the metal substrate before other coatings are applied. Typically, the substrate is pretreated and then primed with a commercially available anticorrosive coating. Various pretreatments and primers are known to those of skill in the art and may vary depending on the type of coating (e.g., coil coatings or spray coatings) and the ultimate end use of the coating. The primer coating has thickness of preferably about 1 to 15 μm, more preferably 5 to 12 μm.

In an embodiment, the present description provides a coated article, i.e. a substrate, preferably a metal substrate, with one or more coating compositions applied thereon in addition to any primer, if already applied to the substrate. The coating may be any type of organic, inorganic or hybrid coating, and any type of liquid coating composition, powder coating composition, or combinations thereof may be used. The coating composition generally includes a film forming resin or binder and optionally, a curing or crosslinking agent for the resin. The binder may be selected from any resin or combination of resins that provides the desired film properties. Suitable examples of polymeric binders including thermoset and/or thermoplastic materials, and can be made with epoxy, polyester, polyurethane, polyamide, acrylic, polyvinylchloride, nylon, fluoropolymer, silicone, other resins, or combinations thereof. Fluoropolymers, acrylics, and combinations thereof are particularly preferred.

In an aspect, the coated article is preferably a substrate with at least a first coating composition applied thereon and cured to form a basecoat on the substrate. In an embodiment, the first coating composition applied on the substrate is a liquid coating composition including one or more binder polymers. Thermoplastic materials are generally preferred for use as polymeric binders in coil coating applications. In a preferred aspect, the polymeric binder includes at least one thermoplastic fluoropolymer, more preferably a polymer derived from at least one fluoroolefin. Suitable fluoroolefins include, without limitation, tetrafluoroethylene, vinylidene difluoride, fluoroethylene, fluoropropylene, and mixtures thereof. In an aspect, the fluoropolymers may include substituents such as, for example, halogen, hydroxyl group, vinyl groups, ether groups, and the like. Polyvinylidene fluoride (PVDF), fluoroethylene vinyl ether (FEVE), and mixtures or combinations thereof are preferred.

In an embodiment, the first coating composition may include one or more additional resin components. Suitable resins include, for example, acrylics, (meth)acrylates, polyester, polyurethane, epoxy, and the like. In a preferred aspect, the first composition includes one or more polymers derived from ethylenically unsaturated monomers. In an aspect, these monomers may be copolymerized with the fluoroolefin in the first coating composition. Suitable ethylenically unsaturated monomers include, for example, ethylene, propylene, isobutylene, styrene, vinyl chloride, vinylidene chloride, vinyl formate, vinyl acetate, vinyl propionate, vinyl butyrate, methyl (meth)acrylate, ethyl (meth)acrylate, (meth)acrylonitrile, N-butoxymethyl (meth)acrylamide, and the like. If the additional resin component is intended to provide thermosetting properties, monomers including crosslinking functionality in the form of —OH, —NCO, —COOH, —NH₂, combinations or mixtures thereof, and the like may be used. In an aspect, acrylic monomers such as (meth)acrylic acid, methyl (meth)acrylate, ethyl (meth)acrylate, styrene, combinations or mixtures thereof, and the like are preferred.

Accordingly, in an embodiment, the first coating composition is a polyvinylidene fluoride (PVDF) or fluoroethylene vinyl ether (FEVE) in combination with an acrylic resin. In an aspect, the first composition preferably includes 20 to 90 wt %, more preferably 30 to 80 wt %, even more preferably 40 to 70 wt % of the fluoropolymer and preferably 10 to 80 wt %, more preferably 20 to 70 wt %, even more preferably 30 to 60 wt % of the acrylic resin. In a preferred aspect, the composition includes 70 wt % fluoropolymer to 30 wt % acrylic.

In an embodiment, the first coating composition further includes one or more pigments. Suitable pigments include, for example, titanium dioxide, silica, iron oxides of various colors, various silicates (e.g., talc, diatomaceous earth, asbestos, mica, clay, lead silicate, etc.), zinc oxide, zinc sulfide, zirconium oxide, lithophone, carbon black, calcium carbonate, barium sulfate, and the like. Leafing and non-leafing metallic pigments may also be used. Organic pigments known to be stable at temperatures used to cure or bake the first coating compositions may also be used. Commercially available versions of the coating composition include, for example, FLUROPON or VALFLON by Valspar, available in a range of colors across a broad color space.

Accordingly, in an embodiment, the first coating composition described herein preferably includes at least one pigment present in an amount of preferably about 1 to 20 wt %, more preferably about 5 to 15 wt %, based on the total weight of the first coating composition.

Suitably, a cured film formed from the first coating composition will have a dry film thickness of about 1 to 50 μm, more preferably 10 to 45 μm, even more preferably 25 to 35 μm. Without limiting to theory, a coating thickness of less than 1 μm would not include sufficient pigment to provide the required degree of color to the cured film. On the other hand, a coating thickness of greater than 40 μm would produce a brittle film that may bend or crack when a coated article is formed from the substrate. In some embodiments, more than one layer of the first coating may be applied, and in such cases, the total thickness of the first coating may vary from preferably about 30 to 60 μm, more preferably 45 to 55 μm.

In an aspect, the coated article preferably includes at least a second coating composition applied over a cured film of the first coating and then cured to form a topcoat on the substrate. In an embodiment, the second coating composition is preferably a polyvinylidene fluoride (PVDF) or fluoroethylene vinyl ether (FEVE) in combination with an acrylic resin. In an aspect, the second composition preferably includes 20 to 90 wt %, more preferably 30 to 80 wt %, even more preferably 40 to 70 wt % of the fluoropolymer and preferably 10 to 80 wt %, more preferably 20 to 70 wt %, even more preferably 30 to 60 wt % of the acrylic resin. In a preferred aspect, the composition includes 70 wt % fluoropolymer to 30 wt % acrylic.

The first and second coating compositions may each independently be a PVDF or FEVE composition. In an embodiment, both the first and second coating compositions are PVDF in combination with an acrylic resin. In an alternate embodiment, both the first and second composition are FEVE in combination with an acrylic resin. In yet another embodiment, the first coating is PVDF in combination with an acrylic resin, while the second coating is FEVE in combination with an acrylic resin, or alternatively, the first coating is FEVE in combination with an acrylic resin and the second coating is PVDF in combination with an acrylic resin.

In an embodiment, the first and second coating compositions are each independently a dispersion of a fluoropolymer in a suitable liquid carrier. In an aspect, the carrier may be aqueous (i.e. water) or non-aqueous, and preferably, the carrier is an organic solvent or blend of solvents. Examples of suitable solvents include, without limitation, aliphatic hydrocarbons (e.g., mineral spirits, kerosene, NAPHTHA solvent, and the like), aromatic hydrocarbons (e.g., benzene, toluene, xylene, and the like), alcohols (e.g., ethanol, propanol, isopropanol, n-butanol, isobutanol, and the like), ketones (e.g., acetone, 2-butanone, cyclohexanone, methyl aryl ketones, ethyl aryl ketones, methyl isoamyl ketones, and the like), esters (e.g., ethyl acetate, butyl acetate, and the like), glycols (e.g., butyl glycol), glycol ethers (e.g., ethylene glycol monomethyl ether, ethylene glycol monoethyl ether, and the like), glycol esters (e.g., butyl glycol acetate, methoxypropyl acetate and the like), reactive diluents (e.g., hexane diacrylate, trimethylol propane diacrylate, 1,6-hexanediol diacrylate, 1,6-hexanediol dimethacrylate, and the like), combinations and mixtures thereof, and the like.

In an embodiment, the second coating composition does not contain pigment other than any effect pigment or additive used to provide a sparkle finish. Typically, the second coating will form a clear, colorless or slightly colored cured film with a sparkle effect over the pigmented first coating. Therefore, the color of the coated article described herein is determined by the type and amount of pigment included in the first coating and the sparkle effect provided by the second coating.

The present description provides a coated article with a sparkle finish, where the sparkle finish is provided by the second coating composition. Conventionally, a sparkle finish or other optically attractive finishes such as metal effect finish, for example, is provided by including mica or alumina in the first coating composition along with one or more pigments to produce a desired color. However, as mica and alumina have flakes or particles of irregular size and aspect ratio, they can produce a non-homogenous surface and consequently, irregular, muddy or distorted color in the basecoat as a result of irregular reflection and/or refraction from the particles. Moreover, this muddying or color distorting effect limits the color space available for sparkle finish coatings. When mica or alumina are incorporated into the clear topcoat, the resulting coating is often hazy or yellow and has a splotchy effect rather than a sparkle effect. In such coatings, it is difficult to control color consistency, both in terms of the uniformity of the color in different areas of the coated article and in terms of the number of colors that can be warrantied for performance over a given period of time.

Surprisingly, and in contrast to conventional metal effect coatings, the coated article described herein has a dramatic sparkle finish in a wide variety of effect colors such as, for example, gold, silver, champagne, and other metallic effect colors, and mixtures and combinations thereof. For example, a conventional metal effect coating in silver or champagne color can be achieved using alumina or mica, but the colors would be limited to just silver or champagne or color-shaded versions of silver or champagne. In contrast, the coated article described herein demonstrates a wide range of colors that sparkle across a significantly expanded color space.

Moreover, the coated article maintains color vibrancy along with sparkle such that an unlimited range of colors across a broad color space is possible. This is achieved by incorporating an effect additive into the second composition, i.e. the topcoat composition rather than in the basecoat composition. This allows color to be presented through the basecoat while the sparkle finish is provided by the effect additive in the clear topcoat, and the combination of the basecoat color and the sparkle finish allows for a wide range of sparkle effects in various color families including gold, red, dark blues, green, black, white, pastels and other rich colors across an almost unlimited color space. FIG. 2 displays a series of test panels with sparkle coatings in a variety of different colors, each prepared using a gold effect additive, i.e. glass flake that provides a gold effect. Within each family of colors, a wide variety of color shades and variations, each with vibrant color and sparkle, may be produced.

Accordingly, in an embodiment, the second coating composition includes an effect additive to provide the desired sparkle finish. In an aspect, the second coating composition preferably includes glass flakes as the effect additive to provide a sparkle effect. These glass flakes are highly transparent platelet-shaped particles of glass coated with a metal oxide to provide a shimmering, sparkling or pearlescent effect. The flakes provide enhanced optical transparency relative to conventional metal effect pigments. Moreover, unlike mica or alumina, the glass flakes have uniform size and aspect ratio along with a homogenous surface. Without limiting to theory, this produces regular reflection and/or refraction from the coated surface and consequently, a dramatic sparkle effect.

The expanded color space possible with the sparkle coating described herein may be assessed in terms of a color scale or color system. Such color systems have three dimensions, in order to include all possible colors, and can be based either on a specific arrangement of predetermined colors or by identifying colors mathematically. In an aspect, the color system used herein is a mathematical scale, preferably the CIE color system. The CIE system is based on mathematical description of the light source, the object(s) and a standard observer. The light reflected or transmitted by an object is measured with a spectrophotometer or similar apparatus or instrument. The data can be mathematically reproduced as three-dimensional CIE color space using the L*a*b* equations, where L* represents lightness, a* represents redness-greenness, and b* represents yellowness-blueness. The quantities on the L*a*b* scale are calculated using equations known in the art.

In an embodiment, the color and sparkle of the coated article described herein may be described using the L*a*b* scale. In an aspect, the coated article demonstrates color and sparkle across an expanded and nearly unlimited color space. The L* (brightness) values range from 0 (black) to 100 (white), a* ranges from −60 (green) to 60 (red), and b* ranges from −60 (blue) to 60 (yellow). Any change in color (ΔE) over time is denoted by a color shift easily observed by visual or instrumental means, such as with a spectrophotometer, for example. The color shift corresponds to a particular number of units on at least one axis of the L*a*b* scale. In a preferred aspect, the coated article described herein shows a color change (ΔE) or preferably less than 10 units, more preferably less than 5 units.

In an aspect, the present description embraces a coating that demonstrates an expanded or extended range of color space relative to a conventional mica-based coating with a sparkle effect. This expanded color space is co-extensive with the color space available with commercial high warranty systems. As used herein, the term “high warranty system” means a colored coating system that is warrantied to have lasting color (i.e. ΔE of less than 5) over an extended period of time (i.e. 10 years) with performance that meets industrial specifications, such as the AAMA 2605 specification, for example. As described herein, a coated article could demonstrate gold, silver, champagne or other metal effects in combination with all the other colors available in the color space while maintaining the same or superior performance as a conventional warranty system.

The degree of color and sparkle can also be assessed in terms of the flop demonstrated by the coating. As used herein, the term “flop” refers to color flop, i.e. a difference in color or appearance of the coated substrate when viewed at two widely different angles. The flop index may be a useful indicator of the degree of sparkle in the coated articles described herein. The flop index is a measurement of the change in reflectance of a metallic color as it rotates through the range of possible viewing angles. A flop index of “0” indicates a solid color (no sparkle or metal effect) while a high flop metallic effect will have a flop index of 15 to 17.

Accordingly, in an aspect, the glass flake included in the second coating composition provides a coated article with a high flop effect. The coated article described herein has a flop index of at least 10, more preferably at least 12, even more preferably at least 15.

Without limiting to theory, the flop index of the coated article may be influenced by the particle size of the effect additive. In an aspect, the second coating composition includes glass flakes with a median particle size (D50) of preferably about 10 to 50 μm, more preferably 20 to 40 μm, even more preferably 25 to 35 μm. Particle sizes of less than 10 μm produces a distorted effect and a muted sparkle, while particles sizes of more than 50 μm do not produce the desired sparkle effect.

Without limiting to theory, the sparkle effect may also depend on the thickness of the cured film formed from the second coating composition. Conventionally, clear topcoats for coil-coated articles have a dry film thickness of about 5 to 10 μm, preferably about 7 to 8 μm. In contrast, the coated articles described herein have a clear topcoat with a dry film thickness of at least about 10 μm, more preferably about 10 to 40 micron, even more preferably about 20 to 30 μm.

In an embodiment, the glass flakes included in the second coating composition produce a high flop index at very low concentration. In an aspect, the second coating composition preferably includes less than about 1 wt %, more preferably less than about 0.5 wt %, and most preferably about 0.01 to 0.2 wt % of the glass flakes, based on the total weight of the second coating composition. Without limiting to theory, a combination of optimal particle size of the glass flakes, optimal concentration of the glass flakes, and optimal thickness of the second coating may combine to provide the desired sparkle finish for the coated article described herein.

In addition to having an optically attractive sparkle finish, the coated article described herein is also abrasion resistant, e.g., the ability to endure fabrication steps required to make a finished coated article. Without limiting to theory, a combination of a glass flake additive of a particular particle size and optimal thickness of the second coating may combine to provide an abrasion-resistant coating. Abrasion resistance may be measured by any method known to those of skill in the art, including for example, the Taber method, where a Taber number is assigned to a coating and specifies the percentage of a test surface abraded after a specified number of abrasion cycles. In an aspect, the sparkle finish coating described herein preferably has a Taber number of less than about 30%, more preferably less than 10%, even more preferably less than 5% over 50 cycles.

The coated article described herein preferably demonstrates optimal weathering or weather resistance. By “weather resistance” is meant the resistance of the coating to degradation by exposure to UV radiation (i.e. sunlight) over an extended period of time. The test is typically performed using an unfiltered weatherometer, preferably a carbon arc unfiltered weatherometer, where the coating is exposed to unfiltered UV radiation for a fixed period of time (e.g. 500 hours, 1000 hours, and the like) intended to simulate direct exposure to sunlight for several years, and under more harsh conditions than conventional accelerated weather testing such as QUV testing, for example. Without limiting to theory, a combination of a glass flake additive of a particular particle size and optimal thickness of the second coating may combine to provide a weather-resistant coating. In an aspect, the coating composition described herein provides weather resistance comparable or even superior to a conventional coating when subjected to weathering testing over a period of 1000 hours.

The first and second coating compositions may each optionally include other additives. These other additives can improve the application of the coating, the heating or curing of that coating, or the performance or appearance of the final coating. Examples of optional additives which may be useful in the composition include: cure catalysts, antioxidants, color stabilizers, slip and mar additives, UV absorbers, hindered amine light stabilizers, photoinitiators, conductivity additives, anti-corrosion additives, fillers, texture agents, degassing additives, flow control agents, mixtures and combinations thereof, and the like.

In an embodiment, the present description provides a method of making a coated article with a sparkle finish. The method include steps for providing a substrate, typically with a primer applied thereon, followed by applying on the substrate a first coating composition including at least a fluorinated resin. A second clear coating composition is applied on the substrate (over the first composition) where the second coating composition includes at least a fluorinated resin and glass flakes. The method further includes the steps of curing the first and second coating compositions sequentially to provide a coated article with sparkle finish.

The coating compositions of the invention may be applied to substrates by any suitable conventional technique such as spraying, roller coating, dip coating and the like. The coating composition is applied in liquid form. After each coating composition is applied, the composition is cured or hardened by heating or baking according to methods well known in the art. Alternatively, each coating composition may be applied over the previous coating prior to cure (i.e. wet on wet application) and the coatings can then be cured or hardened by heating or baking by methods well known in the art. For example, for the compositions described herein, when used as coil coatings, high temperature baking for a time of preferably about 1 to 20 seconds, more preferably 5 to 10 seconds at a temperature of preferably about 300° C. to 400° C., more preferably 315° C. to 371° C. can be used. Typically, sufficient baking in coil coating applications is achieved when the actual temperature of the underlying metal reaches at least 350° C., and more preferably at least 200° C. For spray applications, longer dwell times of about 1 to 20 minutes, preferably 5 to 10 minutes are required, and baking temperatures of 200° C. to 300° C., preferably 200 to 250° C., more preferably 205° C. to 235° C. can be used.

In general, the substrate and coating should be baked at a sufficiently high temperature for a sufficient time so that essentially all solvents are evaporated from the film and chemical reactions between the polymer and the crosslinking agent proceed to the desired degree of completion. The desired degree of completion also varies widely and depends on the particular combination of cured film properties required for a given application.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts and percentages are by weight and all molecular weights are weight average molecular weight. Unless otherwise specified, all chemicals used are commercially available from, for example, Sigma-Aldrich, St. Louis, Mo.

### Test Methods

Unless indicated otherwise, the following test methods were utilized in the Examples that follow.

### Gloss Measurement

Gloss ratings for coatings are determined using a standard test as described in ASTM D523-14 (Standard Test Method for Specular Gloss).

### Example 1

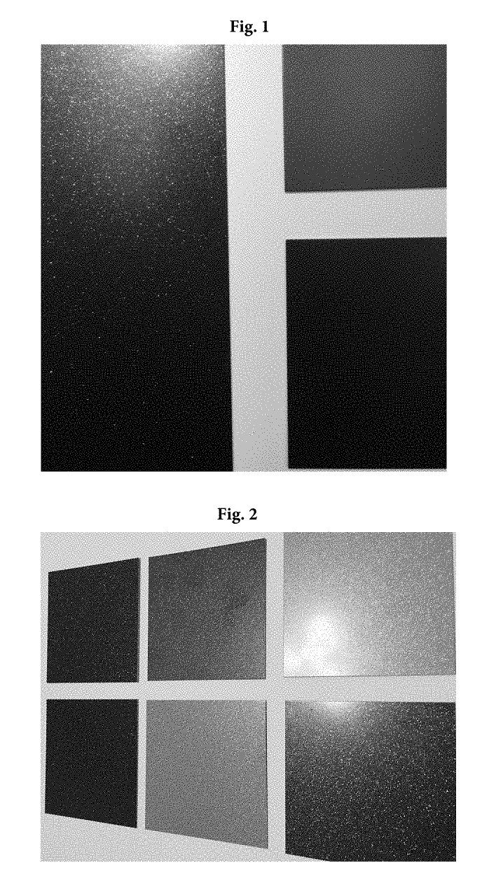

Test samples were prepared by spray-coating pretreated aluminum panels with a black basecoat composition of 70% PVDF (FLUROPON) reduced with xylene, followed by the application of a clear topcoat including about 0.02% glass flake (LUXAN flake from Eckart). For comparison, control test panels were prepared with a black basecoat composition of 70% PVDF (FLUROPON CL II) including a small amount of mica and aluminum flake in the basecoat followed by the application of a clear topcoat. After baking, the test panels were visually analyzed to determine if the desired sparkle finish was obtained. FIG. 1 shows sparkle finish coating according to the present description on the left, with the control panel on the right. As can be seen, the panel on the left demonstrates vibrant color with sparkle while the control panel on the right has a distorted color and very little sparkle effect.

### Example 2

Test samples were prepared by applying a black basecoat composition of 70% FEVE (VALFLON) to pretreated aluminum panels using a coil coating process. This was followed by the application of a clear topcoat and a glass flake effect additive as described in Example 1. Control test panels were prepared with a black basecoat composition of 70% FEVE including a small amount of mica and aluminum flake in the basecoat followed by the application of a clear topcoat. After baking, the test panels were visually analyzed to determine if the desired sparkle finish was obtained. The panel with the glass flake effect additive in the clear coating demonstrated a sparkle finish, while the panel with the control composition had distorted color and little sparkle effect. The panel with the glass flake effect additive also demonstrated 60° gloss of greater than about 80, as determined by ASTM D523.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed is:

1. A coated article, comprising:
a substrate;
a first coating applied on the substrate, the first coating comprising a cured film formed from a first composition including at least a fluorinated resin; and
a second coating applied over the first coating, the second coating comprising a cured film formed from a second composition including at least a fluorinated resin and glass flakes,
wherein the second coating provides the coated article a sparkle finish.

2. The coated article claim 1, wherein the substrate is a metal substrate.

3. The coated article of claim 1, wherein the first coating composition and second coating composition are independently each a dispersion of a fluoroolefin in a solvent.

4. The coated article of claim 1, wherein the fluorinated resin is a polymer derived from vinylidene fluoride.

5. The coated article of claim 1, wherein the fluorinated resin is a polymer derived from fluoroethylene.

6. The coated article of claim 1, wherein the first coating composition and second coating composition are independently each selected from polyvinylidene fluoride (PVDF), fluoroethylene alkyl vinyl ether copolymer (FEVE), and mixtures thereof.

7. The coated article of claim 1, wherein the first coating composition and second coating composition independently each further comprise a resin component selected from (meth)acrylate-derived monomers, polyester, polyurethane, epoxy, or combinations thereof.

8. The coated article of claim 1, wherein the first composition further comprises about 0.1 to 0.5 wt % pigment, based on the total weight of the composition.

9. The coated article of claim 1, wherein the glass flakes are present in an amount of no more than about 1 wt %, based on the total weight of the composition.

10. The coated article of claim 1, wherein the glass flakes have a particle size (D50) of about 10 to 50 μm.

11. A method of making a coated article with a sparkle finish, comprising:
providing a substrate;
applying on the substrate a first coating composition comprising at least a fluorinated resin;
applying on the substrate a second clear coating composition comprising at least a fluorinated resin and glass flakes; and
curing the first coating composition and second coating composition sequentially to form the coated article.

12. The coated article of claim 1, wherein the first coating composition comprises about 70 wt % fluorinated resin, about 30% of an additional resin component, based on the total weight of resin in the composition, and has a pigment-to-binder (P/B) ratio of 0.1 to 1.0.

13. The coated article of claim 1, wherein the first coating has a P/B ratio of about 0.5 to 0.6.

14. The coated article of claim 1, wherein the second coating composition comprises about 70 wt % fluorinated resin, about 30 wt % of an additional resin component, based on the total weight of resin in the composition, and less than about 1 wt % glass flakes.

15. The coated article of claim 1, wherein the article demonstrates L* values of 0 to 100.

16. The coated article of claim 1, wherein the article demonstrates a* values of −60 to 60.

17. The coated article of claim 1, wherein the article demonstrates b* values of −60 to 60.

18. The coated article of claim 1, wherein the coated article demonstrates a flop index of at least 10.

19. The coated article of claim 1, wherein the coated article demonstrates a flop index of at least 15.
